(19) United States
(12) Patent Application Publication
(10) Pub. No.: US 2026/0099397 A1
(43) Pub. Date: Apr. 9, 2026

(54) SYSTEMS AND METHODS FOR DYNAMIC DATA SERVER FAULT STEERING IN A DISTRIBUTED NETWORK

(71) Applicant: BANK OF AMERICA CORPORATION, Charlotte, NC (US)

(72) Inventor: Jonathan McGuire, Jacksonville, FL (US)

(73) Assignee: BANK OF AMERICA CORPORATION, Charlotte, NC (US)

(21) Appl. No.: 18/908,076

(22) Filed: Oct. 7, 2024

(51) Int. Cl. G06F 11/07

(52) U.S. Cl. CPC G06F 11/079; G06F 11/0709; G06F 11/0793

(57) ABSTRACT

Systems, methods, and computer program products are provided herein for dynamic data server fault steering in a distributed network. An example method includes receiving one or more data transmissions from a plurality of server devices forming a distributed network and extracting one or more device characteristics from the one or more data transmissions. The extracted device characteristics are indicative of at least a fault condition associated with one or more of the server devices from amongst the plurality of server devices forming the distributed network. The method also includes determining a remediation destination for the fault condition based on the extracted device characteristics and generating a remediation transmission for receipt by the determined remediation destination. The determined remediation destination is configured to remedy the fault condition associated with the one or more server devices.

### TECHNOLOGICAL FIELD

Example embodiments of the present disclosure relate generally to distributed networks and, more particularly, to systems and methods for dynamic data server fault steering in these network implementations.

### BACKGROUND

Electronic systems, communication systems, and/or other distributed networks may be formed of various computing devices, server devices, and/or the like that are associated with a plurality of applications, operations, etc. These devices may periodically be subjected to errors, faults, maintenance, etc. that reduce or prevent the ability of the devices to perform their associated operations. Applicant has identified a number of deficiencies and problems associated with conventional systems and associated methods. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided herein for dynamic data server fault steering. In one aspect, a system for dynamic data server fault steering in distributed networks may include at least one non-transitory storage device and at least one processor coupled to the at least one non-transitory storage device. The processor may be configured to receive one or more data transmissions from a plurality of server devices forming a distributed network and extract one or more device characteristics from the one or more data transmissions. The extracted device characteristics may be indicative of at least a fault condition associated with one or more of the server devices from amongst the plurality of server devices forming the distributed network. The processor may determine a remediation destination for the fault condition based on the extracted device characteristics and generate a remediation transmission for receipt by the determined remediation destination. The determined remediation destination may be configured to remedy the fault condition associated with the one or more server devices.

In some embodiments, in extracting the one or more device characteristics, the at least one processor may be further configured to compare one or more fault designations from the one or more extracted device characteristics with one or more fault identifiers and determine a corresponding fault identifier for the one or more server devices based on the comparison.

In some further embodiments, the at least one processor may be further configured to determine an absence of a corresponding fault identifier for the one or more fault designations.

In some further embodiments, the at least one processor may be further configured to generate a new fault identifier corresponding to the one or more fault designation absent from the one or more fault identifiers.

Additionally or alternatively, in some embodiments, the at least one processor may be further configured to generate a data linkage between the fault designation absent from the one or more fault identifiers and at least one or the one or more fault identifiers.

In some embodiments, the at least one processor may be further configured to deploy a trained machine learning (ML) model on the one or more fault designations from the one or more extracted device characteristics to determine a corresponding fault identifier.

In some embodiments, in determining the remediation destination for the fault condition, the at least one processor may be further configured to access a data structure storing a plurality of candidate remediation destinations and determine the remediation destination from amongst the plurality of candidate remediation destinations based on the extracted device characteristics.

In some further embodiments, the at least one processor may be configured to dynamically modify the data structure to add or remove candidate remediation destinations.

In some further embodiment, the at least one processor may be further configured to modify the data structure responsive to a change in access credentials associated with one or more of the candidate remediation destinations.

In any embodiment, the determined remediation destination may include a plurality of remediation destinations, and the remediation transmission is configured for receipt by the plurality of remediation destinations.

In another aspect, a computer program product for dynamic data server fault steering in distributed networks is provided. The computer program product may include a non-transitory computer-readable medium including code that, when executed, causes an apparatus to receive one or more data transmissions from a plurality of server devices forming a distributed network, extract one or more device characteristics from the one or more data transmissions, where the extracted device characteristics may be indicative of at least a fault condition associated with one or more of the server devices from amongst the plurality of server devices forming the distributed network, determine a remediation destination for the fault condition based on the extracted device characteristics, and generate a remediation transmission for receipt by the determined remediation destination. The determined remediation destination may be configured to remedy the fault condition associated with the one or more server devices.

In another aspect, a method for dynamic data server fault steering in distributed networks is provided. The method may include receiving one or more data transmissions from a plurality of server devices forming a distributed network, extracting one or more device characteristics from the one or more data transmissions, where the extracted device characteristics may be indicative of at least a fault condition associated with one or more of the server devices from amongst the plurality of server devices forming the distributed network, determining a remediation destination for the fault condition based on the extracted device characteristics, and generating a remediation transmission for receipt by the determined remediation destination. The determined remediation destination may be configured to remedy the fault condition associated with the one or more server devices.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below. The features, functions, and advantages that are described herein may be achieved independently in various embodiments of the present disclosure or may be combined with yet other embodiments.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIGS. 1A-1C illustrate technical components of an exemplary distributed computing environment for dynamic data server fault steering in a distributed network in accordance with one or more embodiments of the present disclosure;

FIG. 2 illustrates an example method for dynamic data server fault steering in a distributed network in accordance with one or more embodiments of the present disclosure;

FIG. 3 illustrates an example method for fault designation comparisons in accordance with one or more embodiments of the present disclosure; and

FIG. 4 illustrates an example method for remediation destination determinations in accordance with one or more embodiments of the present disclosure.

### DETAILED DESCRIPTION

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, this data may be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with or who otherwise interacts with an entity. As such, in some embodiments, the user may be an individual having past relationships, current relationships, and/or potential future relationships with an entity. In some embodiments, the user may be an employee (e.g., an associate, a project manager, an IT specialist, a manager, an administrator, an internal operations analyst, or the like) of the entity or enterprises affiliated with the entity. In some embodiments, the user may be a customer (e.g., individual, business, etc.) that transacts with the entity or enterprises associated with the entity. In some embodiments, the “user(s)” described herein may refer to a user, system, device, etc. associated with a third party service provider. By way of a non-limiting example, the remediation destination described hereinafter may be associated with a system, device, and/or user of a third-party service provider.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users. As described hereinafter, a user interface of the present disclosure may be configured comprise a visual representation of a fault condition for one or more server devices forming a distributed network. The present disclosure contemplates that the arrangement, presentation, organization, etc. of the user interfaces described herein may vary based upon the intended application of the system.

As used herein, an “engine” or “module” may refer to core elements of an application, or part of an application that serves as a foundation for a larger piece of software and drives the functionality of the software. In some embodiments, an engine or module may be self-contained, but externally-controllable code that encapsulates powerful logic designed to perform or execute a specific type of function. In one aspect, an engine or module may be underlying source code that establishes file hierarchy, input and output methods, and how a specific part of an application interacts or communicates with other software and/or hardware. The specific components of an engine or module may vary based on the needs of the specific application as part of the larger piece of software. In some embodiments, an engine or module may be configured to retrieve resources created in other applications, which may then be ported into the engine for use during specific operational aspects of the engine. An engine or module may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

It should also be understood that “operatively coupled,” “communicably coupled” and/or the like as used herein, means that the components may be formed integrally with each other, or may be formed separately and coupled together. Furthermore, the components may be formed directly to each other, or to each other with one or more components located between the components that are operatively coupled together. Furthermore, the components may be detachable from each other, or they may permanently coupled together. Furthermore, operatively coupled components may mean that the components retain at least some freedom of movement in one or more directions or may be rotated about an axis (e.g., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer or transmission of data between devices, a system and an application, an accessing of stored data by one or more nodes of a computing cluster, a transmission of a requested task, or the like. As described hereinafter, an “interaction” between the system and one or more applications may be permissioned in that the ability for the system (e.g., one or more devices, subsystems, modules, etc.) to access a particular application may be controlled by permissions issued by this application.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a criterion, including that a threshold has been met, passed, exceeded, etc.

As described above, electronic networks formed of distributed components may interact with a variety of applications in order to perform the various operations associated with the network. By way of a particular example, a distributed network may be formed of a plurality of server devices, each of which may be associated with the same or different operations, applications, user, etc. These server devices may periodically be subjected to errors, faults, maintenance, etc. that reduce or prevent the ability of the devices to perform their associated operations. In order to address these fault conditions, conventional systems require that an operator or other user associated with the system identify the particular fault condition and manually determine the appropriate parties for correcting or otherwise addressing the fault condition. In large, distributed networks formed of numerous server devices, however, the ability of users to manually address the directing of these fault conditions is impossible or impractical. Furthermore conventional systems, fail to account for dynamically changing groups of users, teams, etc. that may be associated with a particular fault condition. Said differently, traditional system are incapable of effectively steering fault conditions associated with data servers in distributed networks.

In order to solve these issues and others, embodiments of the present disclosure provide systems and methods for dynamic data server fault steering in distributed networks. For example, the embodiments described herein may receive data transmissions from a plurality of server devices that form a distributed network and extract device characteristics from the one or more data transmissions. These extracted device characteristics are indicative of at least a fault condition associated with the server devices forming the distributed network. These embodiments may further determine a remediation destination for the fault condition based on the extracted device characteristics and generate a remediation transmission for receipt by the determined remediation destination. The system may further leverage machine learning (ML) model and artificial intelligence (AI) techniques to determined fault designations for these server devices and may further dynamically modify data structures formed of candidate remediation destinations. In doing so, the embodiments of the present disclosure provide new mechanisms for effectively determining fault conditions associated with server devices in distributed networks and efficiently steering these fault conditions to remediation destinations (e.g. users, devices, etc.) for review and correction.

### Example System and Circuitry Components

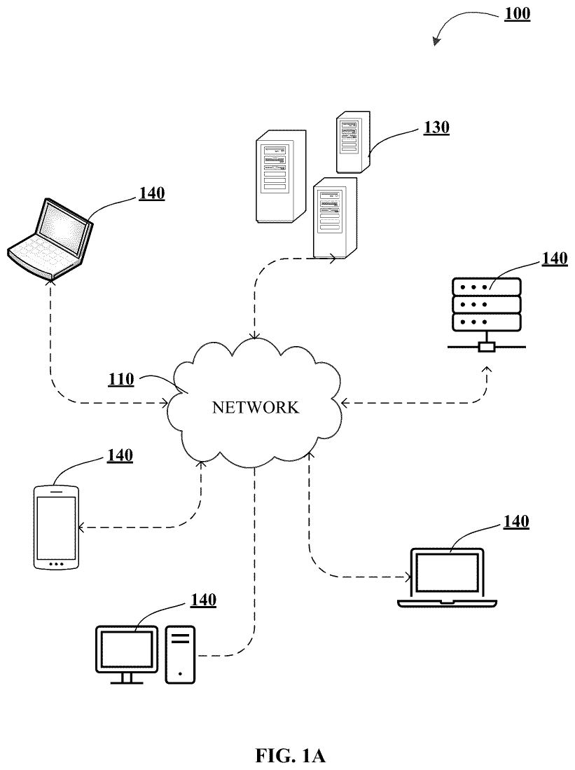

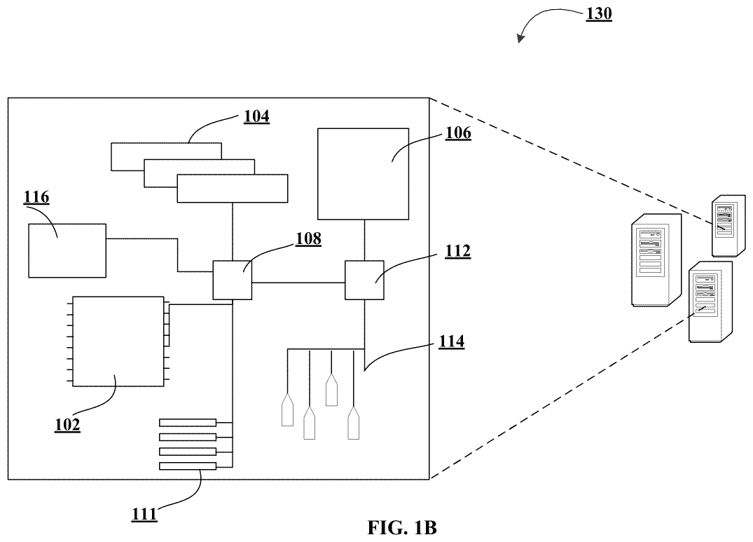

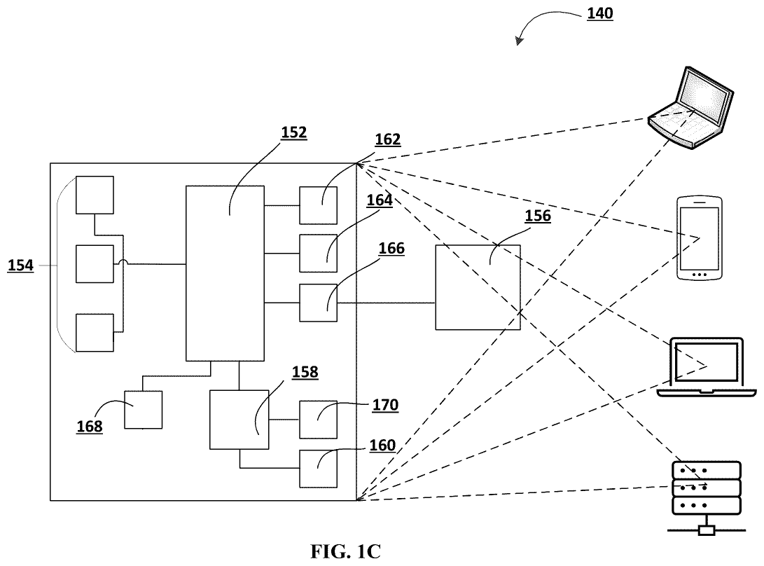

FIGS. 1A-1C illustrate technical components of an exemplary distributed computing environment for dynamic data server fault steering in a distributed network 100, in accordance with one or more embodiments of the present disclosure. As shown in FIG. 1A, the distributed computing environment 100 or distributed network 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, the same or similar to system 130, with each system providing portions of the necessary operations (e.g., as a server bank, a group of blade servers, or a multi-processor system).

In some embodiments, the system 130 and the end-point device(s) 140 may define a client-server relationship in which the end-point device(s) 140 are remote devices that request and receive service from a centralized server (e.g., the system 130). In some other embodiments, the system 130 and the end-point device(s) 140 may have a peer-to-peer relationship in which the system 130 and the end-point device(s) 140 have the same abilities to use the resources available on the network 110. As opposed to relying upon a central server (e.g., system 130) that acts as the shared drive, each device that is connected to the network 110 acts as the server for the files stored thereon.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., an automated teller machine (ATM)), and/or edge devices such as routers, routing switches, integrated access devices (IAD), and/or the like. As described hereinafter, in some embodiments, the end-point devices 140 may be server devices that are communicably coupled with the system 130 over the network. In such an embodiments, the system 130 may operate as the hardware, software, etc. for performing the data server fault steering operations described herein for steering fault conditions associated with the server devices (e.g., end-point devices 140).

The network 110 may be a distributed network that is spread over different networks. This provides a single data communication network that may be managed jointly or separately by each network. In addition to shared communication within the network, the distributed network may also support distributed processing. The network 110 may be a form of digital communication network, such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the embodiments of the present disclosure. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with one or more embodiments of the present disclosure. As shown in FIG. 1B, the system 130 may include a processor 102, memory 104, input/output (I/O) device 116, and/or a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 may process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 may be capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and/or to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other. As described herein, in some embodiments, the system 130 may operate as the centralized server configured to perform the dynamic data server fault steering operations described herein.

FIG. 1C illustrates an exemplary component-level structure of the end-point device(s) 140 (e.g., server devices described herein), in accordance with one or more embodiments of the present disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a Microdrive or other device, to provide additional storage. Each of the components 152, 154, 158, and 160, are interconnected using various buses, and several of the components may be mounted on a common motherboard or in other manners as appropriate. As described above, the end-point devices 140 described herein may be server devices that form the distributed network. As such, the system 130 may be communicably coupled with the server devices (e.g., end-point devices 140) so as to receive data transmissions from these devices that may, for example, be indicative of fault conditions for these server devices.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user (e.g., an actionable notification or the like). The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 may be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 (e.g., server devices) to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 (e.g., server devices) may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 (e.g., server devices) may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130. Various implementations of the distributed computing environment 100, including the system 130 and end-point device(s) 140 (e.g., server devices), and techniques described here may be realized in digital electronic circuitry, integrated circuitry, specially designed ASICs (application specific integrated circuits), computer hardware, firmware, software, and/or combinations thereof.

### Example Methods Dynamic Data Server Fault Steering

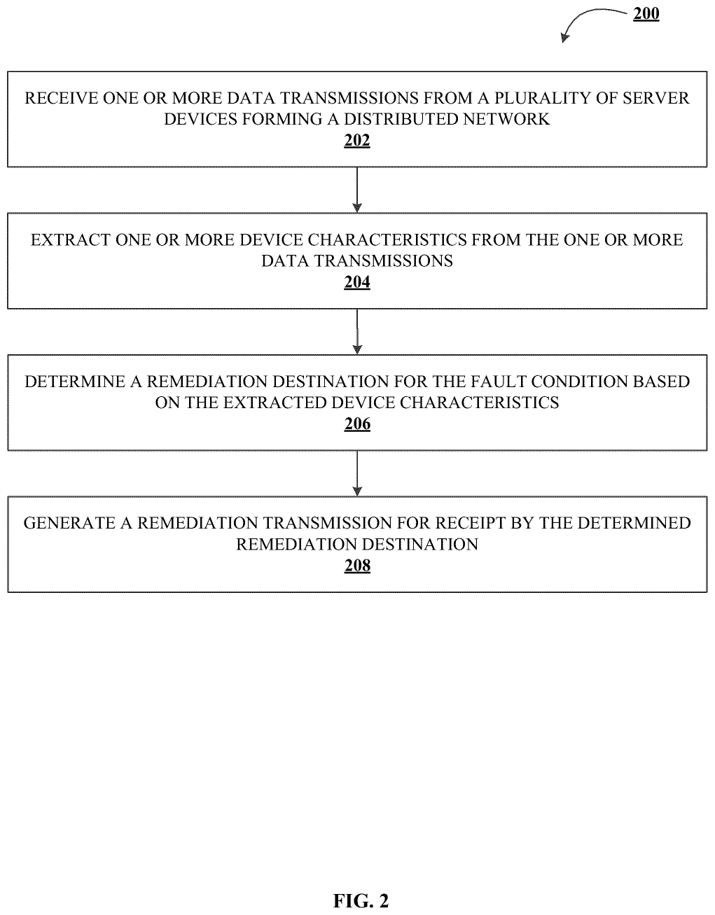

FIG. 2 illustrates a flowchart containing a series of operations for example dynamic data server fault steering in a distributed network (e.g., method 200). The operations illustrated in FIG. 2 may, for example, be performed by, with the assistance of, and/or under the control of an apparatus (e.g., system 130, end-point devices 140 (e.g., server devices), etc.), as described above. In this regard, performance of the operations may invoke one or more of the components described above with reference to FIGS. 1A-1C (e.g., processor 102, processor 152, etc.).

As shown in operation 202, the system 130 may be configured to receive one or more data transmissions from a plurality of server devices forming a distributed network. As described above, the system 130 may operate as a centralized server or other computing device that is communicably coupled with a plurality of server devices (e.g., end-point devices 140) forming a distributed network. The system 130 may be configured to receive communications, such as over network 110, from the various server devices forming the distributed network. In some embodiments, the system 130 may receive data transmissions from the server devices (e.g., end-point devices 140) periodically (e.g., according to a determined frequency) regardless of the existence of a fault condition as described hereafter. Said differently, the system 130 may routinely receive data transmission from the devices with which it interacts. In other embodiments, the system 130 may be configured to receive data transmissions from the server devices (e.g., end-point devices 140) in response to the existence of a fault condition. By way of a nonlimiting example, a particular server device (e.g., end-point device 140) may experience a fault condition and transmit a data transmission that includes an error code or similar identifier, designation, etc. associated with the fault condition. Although described hereinafter with reference to a fault condition that may be associated with an error code, system failure, etc. for the server devices (e.g., end-point devices 140), the present disclosure contemplates that the server fault conditions described herein may be indicative of any status, condition, attribute, characteristics, parameter, etc. for the server devices (e.g., end-point devices 140) without limitation and regardless of if a fault or failure has occurred.

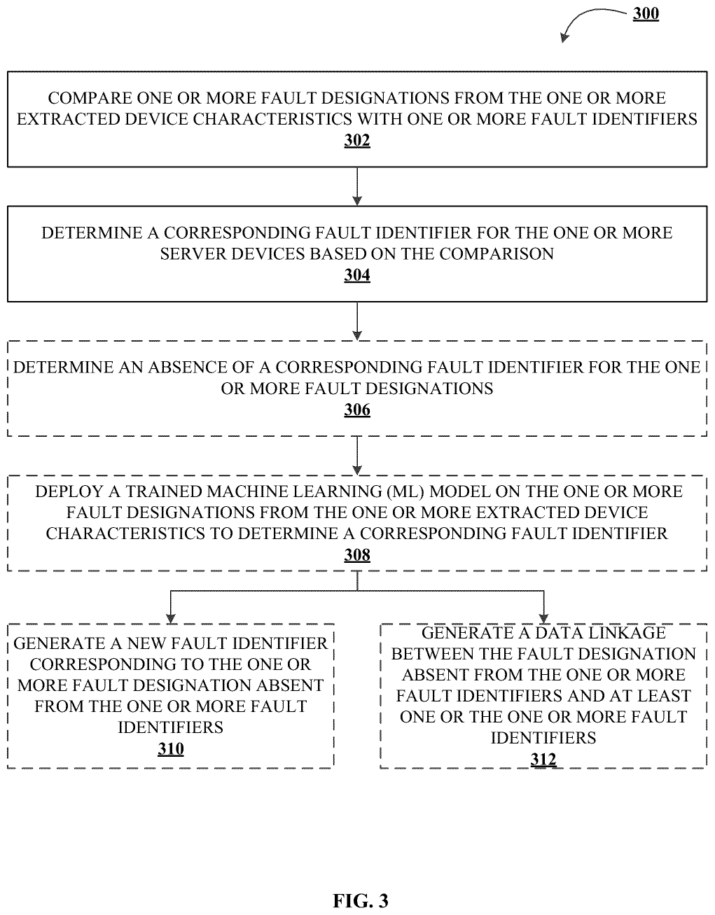

Thereafter, as shown in operation 204, the system 130 may be configured to extract one or more device characteristics from the one or more data transmissions. As described hereafter with reference to FIG. 3, the data transmissions may include various data entries associated with or otherwise indicative of the server device (e.g., end-point device 140) from which the system 130 receives the data transmission. The extracted device characteristics may, for example, be indicative of at least a fault condition associated with one or more of the server devices (e.g., end-point devices 140) from amongst the plurality of server devices (e.g., end-point devices 140) forming the distributed network. In some embodiments, the device characteristics may provide identifying information for the server devices (end-point device 140), such as identification numbers, applications associated with the device, users (e.g., operators, teams, etc.) associated with the device, server type, among others. As described above, in some embodiments, the extracted device characteristics may be indicative of an error code or other fault identification mechanism. Although described hereinafter with reference to extracted device characteristics that are indicative of a fault condition for one or more server devices (e.g., end-point device 140), the present disclosure contemplates that the device characteristics may be indicative of any status, condition, attribute, characteristics, parameter, etc. for the server devices (e.g., end-point devices 140). For example, the device characteristics may be indicative of performance of the server device (e.g., central processing unit (CPU) utilization, memory utilization, server heat, environmental conditions, etc.), interactions with the server device (e.g., data throughput, user access, etc.), and/or the like without limitation.

As described hereafter with reference to FIG. 3, in some embodiments, the data entries that form the data transmission may explicitly provide identifying data to the system 130. In such an embodiment, the extraction of the device characteristics may require only the identification of the corresponding data entry in the data transmission. In some embodiments, however, the format, structure, etc. of the data transmission may differ from the format, structure, etc. leveraged by the system 130. In such an embodiment, the system 130 may be configured to perform one or more data conversion or translations operations such that the data entries extracted from the data transmission are in a structure, format, etc. that is usable by the system 130. In other embodiments, the data transmission may fail to explicitly provide data to the system 130. In such an embodiment, the system 130 may be configured to deploy trained ML models on the data transmission to extract various data characteristics as described hereafter.

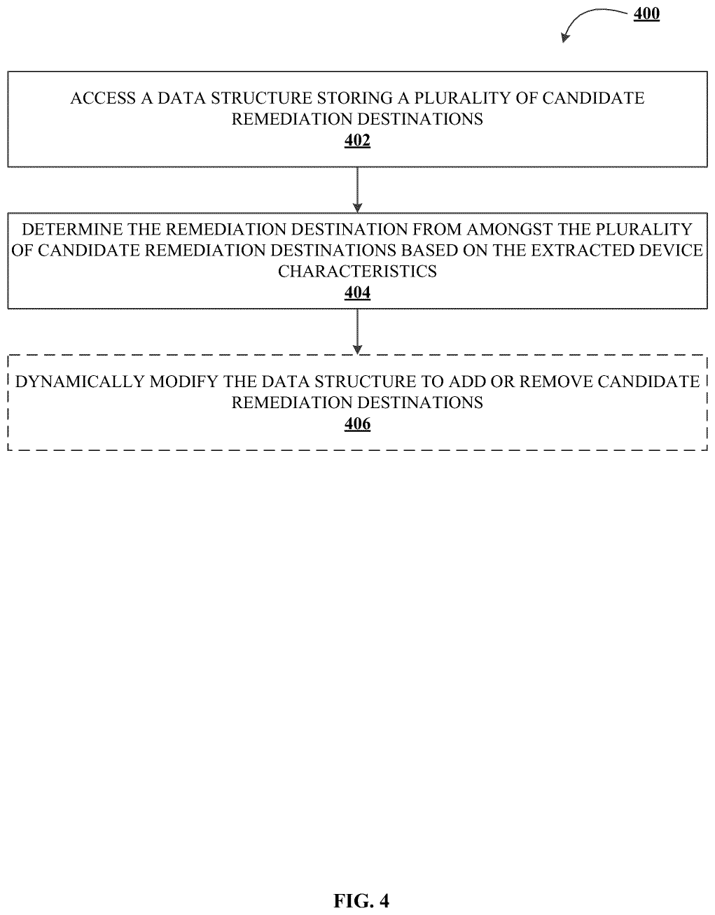

Thereafter, as shown in operation 206, the system 130 may be configured to determine a remediation destination for the fault condition based on the extracted device characteristics. As described above, the server devices (e.g., end-point devices 140) described herein may be associated with a particular server type and/or may be configured to perform various applications, operations, etc. As would be evident to one of ordinary skill in the art in light of the present application, a fault condition for any particular server device (e.g., end-point device 140) may have a set of defined group, team, device, user, etc. that may be associated with the remediation of this fault condition. By way of nonlimiting example, the device characteristics extracted from the data transmission at operation 204 may include error codes or equivalent identifiers indicative of the fault condition for the particular server device (e.g., end-point device 140). In such an example, the extracted error code may have a defined set of devices, users, etc. that are associated with remediation of the subject error code. As described hereinafter with reference to FIG. 4, in some embodiments, the system 130 may access a data structure storing a plurality of candidate remediation destinations in order to determine the remediation destination for the subject fault condition (e.g., error code or the like). The system 130 may operate to dynamically modify the contents of the data structure (e.g., adding and/or removing candidate remediation destinations), such as in response to a change in access credentials for the remediation destination stored therein. By way of a nonlimiting example, the system 130 may retrieve a set of candidate remediation destinations based on an error code extracted from the data transmission.

Thereafter, as shown in operation 208, the system 130 may be configured to generate a remediation transmission for receipt by the determined remediation destination. As described herein, the determined remediation destination may be configured to remedy the fault condition associated with the one or more server devices (e.g., end-point devices 140). By way of continued, non-limiting example, the device characteristics extracted at operation 204 may include error codes indicative of a fault condition for at least one server device (e.g., end-point device 140). The system 130 may determine a plurality of remediation destinations based on the extracted error code, and these remediation destinations may refer to users (e.g., a set of user account credentials, contact information, etc.) associated with the error code, a set of devices (e.g., computing devices, mobile devices, etc.) associated with the error code, and/or the like.

In some embodiments, the determined remediation destination includes a plurality of remediation destinations, and the remediation transmission is configured for receipt by the plurality of remediation destinations. As would be evident to one of ordinary skill in the art in light of the present disclosure, a particular server device (e.g., end-point device 140) and its associated fault condition may implicate any number of dependent or related devices, users, and/or the like. For example, a fault condition of a first server device may cause related faults in other server devices that rely upon the operation of the first server. As such, in some embodiments, the remediation transmission generated at operation 208 may be received by a plurality of devices, users, etc. associated with these dependent or related server devices (e.g., end-point device 140).

In some embodiments, the remediation transmission may operate to generate a user interface comprising a visual representation of the fault condition. By way of example, the remediation destination may be associated with or accessible by a plurality of users, operators, devices, etc. As such, these users, operators, etc. may periodically review the remediation transmission received. To facilitate ease of use by the users, operators, etc., the system 130 may generate a user interface that displays (e.g., comprises a visual representation), the remediation transmission. As would be evident to one of ordinary skill in the art in light of the present disclosure, the user interface may display various actional objects configured to receive a user input. By way of a non-limiting example, the user interface may present actionable objects that allow a user to accept or decline the remediation transmission.

FIG. 3 illustrates a flowchart containing a series of operations for fault designation comparisons (e.g., method 300). The operations illustrated in FIG. 3 may, for example, be performed by, with the assistance of, and/or under the control of an apparatus (e.g., system 130, end-point devices 140 (e.g., server devices), etc.), as described above. In this regard, performance of the operations may invoke one or more of the components described above with reference to FIGS. 1A-1C (e.g., processor 102, processor 152, etc.).

As shown in operation 302, in some embodiments, the system 130 may be configured to compare one or more fault designations from the one or more extracted device characteristics with one or more fault identifiers. As described above, the system 130 may, via a centralized and secure database, store various fault identifiers associated with determined or otherwise known fault conditions. In some embodiments, these fault identifiers may be set by a system administrator. As such, the comparison at operation 302 may refer to a comparison between one or more fault designation that are extracted as part of extracting the device characteristics as described above with reference to FIG. 2. Said differently, the extraction of the device characteristics at operation 204 may be configured to extract data entries that are indicative of the condition (e.g., fault condition) of the server devices (e.g., end-point devices 140). The system 130 may compare these fault designations with the stored fault identifiers.

Thereafter, as shown in operation 304, the system 130 may determine a corresponding fault identifier for the one or more server devices based on the comparison. As described further hereafter, in some embodiments, the one or more fault designations may match or be otherwise associated with the fault identifiers accessed by the system 130. In such an embodiment, the system 130 may be configured to determine that the matching between the fault designations indicates that the extracted fault designations are the same as the access fault identifiers. By way of a nonlimiting example, the extracted fault designations may refer to an error code received via the data transmission that matches a corresponding error code (e.g., fault identifier) accessed by the system 130.

Thereafter, in some embodiments, the system 130 may determine an absence of a corresponding fault identifier for the one or more fault designations. By way of example, in some embodiments, the system 130 may receive data transmissions with data entries that fail to match the fault identifiers accessed by the system 130. In some instances, the extracted device characteristics indicative of a fault condition may be incorrectly entered, associated with a new fault condition, or otherwise unknown or absent from the fault indicators accessed by the system 130. In order to generate a remediation transmission in such an instance, the system 130 may leverage ML models, may generate new fault identifiers, and/or may generate data linkages between the absent fault designation and the fault identifiers.

In some embodiments, as shown in operation 308, the system 130 may be configured to deploy a trained machine learning (ML) model on the one or more fault designations from the one or more extracted device characteristics to determine a corresponding fault identifier. The trained ML model may also refer to a mathematical model generated by machine learning algorithms based on training data (e.g., various feature sets of access permissions), to make predictions or decisions without being explicitly programmed to do so. The trained ML model may similarly represent what was learned by the selected machine learning algorithm and represent the rules, numbers, and any other algorithm-specific data structures required for decision-making. Selecting the right machine learning algorithm may depend on a number of different factors, such as the problem statement and the kind of output needed, type and size of the data, the available computational time, number of features and observations in the data, and/or the like. The trained ML model or algorithm may also refer to programs that are configured to self-adjust and perform better as they are exposed to more data. To this extent, the trained ML model or algorithm is also capable of adjusting its own parameters, based on previous performance in making prediction about a dataset.

The ML algorithms contemplated, described, and/or used herein (e.g., the trained ML model) may include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

The ML models may be trained using repeated execution cycles of experimentation, testing, and tuning to modify the performance of the ML algorithm and refine the results in preparation for deployment of those results for consumption or decision making. The ML models may be tuned by dynamically varying hyperparameters in each iteration (e.g., number of trees in a tree-based algorithm or the value of alpha in a linear algorithm), running the algorithm on the data again, and then comparing its performance on a validation set to determine which set of hyperparameters results in the most accurate model. The accuracy of the model is the measurement used to determine which set of hyperparameters is best at identifying relationships and patterns between variables in a dataset based on the input, or training data. A fully trained ML model is one whose hyperparameters are tuned and model accuracy maximized.

In other embodiments, as shown in operation 310, the system 130 may be configured to generate a new fault identifier corresponding to the one or more fault designation absent from the one or more fault identifiers. By way of example, in some instances, the fault designations extracted by the system 130 may be indicative of fault conditions of first impression (e.g., new or otherwise unknown to the system 130). In such an embodiment, the system 130 may be configured to generate a new fault indicator that corresponds to the fault designation. Alternatively, in other embodiments, as shown in operation 312, the system 130 may generate a data linkage between the fault designation absent from the one or more fault identifiers and at least one or the one or more fault identifiers. By way of example, the fault designation(s) extracted from the data transmission (e.g., the device characteristics) may differ in name from the fault identifiers accessed by the system 130 but may correspond in remediation action. As such, the system 130 may generate a data linkage such that subsequent comparisons for the fault designation correspond to the particular fault identifier.

FIG. 4 illustrates a flowchart containing a series of operations for remediation destination determinations (e.g., method 400). The operations illustrated in FIG. 4 may, for example, be performed by, with the assistance of, and/or under the control of an apparatus (e.g., system 130, end-point devices 140 (e.g., server devices), etc.), as described above. In this regard, performance of the operations may invoke one or more of the components described above with reference to FIGS. 1A-1C (e.g., processor 102, processor 152, etc.).

As shown in operation 402, in some embodiments, the system 130 may access a data structure storing a plurality of candidate remediation destinations. By way of example, the system 130 may be associated with or otherwise communicably coupled with a database, data repository, data structure, or the like that stores potential or candidate remediation locations, such as candidate devices, users, etc. By way of a nonlimiting example, the system 130 may store user identifiers, user contact information, device identifiers, device contact information, etc. that may receive a remediation transmission (e.g., based on the extract device characteristics). These candidate remediation destinations may be grouped, sorted, and/or the like based on application type, role type, server type, and/or the like. The present disclosure contemplates that the data structure storing the candidate remediation destinations may be partitioned, grouped, sorted, and/or the like based on any number of parameters, attributes, characteristics, etc. for the server devices (e.g., end-point devices 140), the system 130, etc.

Thereafter, as shown in operation 404, the system 130 may determine the remediation destination from amongst the plurality of candidate remediation destinations based on the extracted device characteristics. By way of continued example, the candidate remediation destinations may be associated with particular device characteristics, fault designations, fault identifiers, etc. such that the system 130 may compare the extracted device characteristics from the data transmission in order to determine at least one remediation destination that includes or is otherwise associated with the particular extracted device characteristics. In some instances, for example, the extracted device characteristics may include an error corde (e.g., fault designation and/or fault identifier), and the candidate remediation destinations may be stored in the data structure based on error code. Therefore, operation 404 may include determining the remediation destination by matching the extracted error code with candidate remediation destinations that share this error code. Although described herein with reference to error codes, the present disclosure contemplates that any extracted device characteristic may be used to determine the remediation destinations from amongst the plurality of candidate remediation destinations.

In some embodiments, as shown in operation 406, the system 130 may be configured to dynamically modify the data structure to add or remove candidate remediation destinations. By way of example, the data structure may store candidate remediation destinations based on the ability of the candidate remediation destinations to access particular data, applications, etc. In some instances, for example, the candidate remediation destination may refer to a user with an associated user device that currently has access to (e.g., has valid access credentials for) the server device having the fault condition. Over time, the ability of this user to access the server may change (e.g., access credentials may be invalidated). The system 130, in such an embodiment, may operate to modify the data structure to add or remove candidate remediation destinations, such as responsive to a change in access credentials associated with one or more of the candidate remediation destinations. Although described herein with reference to access credentials for a candidate remediation destination, the present disclosure contemplates that the system 130 may be configured to modify the data structure in response to any change in data, configuration, dependency, etc. associated with the candidate remediation destinations within the data structure.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present disclosure may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present disclosure may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present disclosure, however, the computer-readable medium may be transitory, such as a propagation signal including computer-executable program code portions embodied therein.

It will also be understood that one or more computer-executable program code portions for carrying out the specialized operations of the present disclosure may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present disclosure are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present disclosure are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that may direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present disclosure.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments may be configured without departing from the scope and spirit of the disclosure. Therefore, it is to be understood that, within the scope of the appended claims, the disclosure may be practiced other than as specifically described herein.

1. A system for dynamic data server fault steering in a distributed network, the system comprising:
at least one non-transitory storage device; and
at least one processor coupled to the at least one non-transitory storage device, wherein the at least one processor is configured to:
receive one or more data transmissions from a plurality of server devices forming a distributed network;
extract one or more device characteristics from the one or more data transmissions, wherein the extracted device characteristics are indicative of at least a fault condition associated with one or more of the server devices from amongst the plurality of server devices forming the distributed network;
compare one or more fault designations from the one or more extracted device characteristics with one or more fault identifiers;
determine a corresponding fault identifier for the one or more server devices based on the comparison;
determine a remediation destination for the fault condition based on the extracted device characteristics;
generate a remediation transmission for receipt by the determined remediation destination, wherein the determined remediation destination is configured to remedy the fault condition associated with the one or more server devices; and
determine an absence of a corresponding fault identifier for the one or more fault designations.

2. (canceled)

3. (canceled)

4. The system of claim 1, wherein the at least one processor is further configured to generate a new fault identifier corresponding to the one or more fault designation absent from the one or more fault identifiers.

5. The system of claim 1, wherein the at least one processor is further configured to generate a data linkage between the fault designation absent from the one or more fault identifiers and at least one or the one or more fault identifiers.

6. The system of claim 1, wherein the at least one processor is further configured to deploy a trained machine learning (ML) model on the one or more fault designations from the one or more extracted device characteristics to determine a corresponding fault identifier.

7. The system of claim 1, wherein, in determining the remediation destination for the fault condition, the at least one processor is further configured to:
access a data structure storing a plurality of candidate remediation destinations; and
determine the remediation destination from amongst the plurality of candidate remediation destinations based on the extracted device characteristics.

8. The system of claim 7, wherein the at least one processor is configured to dynamically modify the data structure to add or remove candidate remediation destinations.

9. The system of claim 8, wherein the at least one processor is further configured to modify the data structure responsive to a change in access credentials associated with one or more of the candidate remediation destinations.

10. The system of claim 1, wherein the determined remediation destination comprises a plurality of remediation destinations, and the remediation transmission is configured for receipt by the plurality of remediation destinations.

11. A computer program product for dynamic data server fault steering in a distributed network, the computer program product comprising a non-transitory computer-readable medium comprising code that, when executed, causes an apparatus to:
receive one or more data transmissions from a plurality of server devices forming a distributed network;
extract one or more device characteristics from the one or more data transmissions, wherein the extracted device characteristics are indicative of at least a fault condition associated with one or more of the server devices from amongst the plurality of server devices forming the distributed network;
compare one or more fault designations from the one or more extracted device characteristics with one or more fault identifiers;
determine a corresponding fault identifier for the one or more server devices based on the comparison;
determine a remediation destination for the fault condition based on the extracted device characteristics;
generate a remediation transmission for receipt by the determined remediation destination, wherein the determined remediation destination is configured to remedy the fault condition associated with the one or more server devices; and
determine an absence of a corresponding fault identifier for the one or more fault designations.

12. (canceled)

13. The computer program product of claim 11, further comprising code that, when executed, causes the apparatus to:
generate a new fault identifier corresponding to the one or more fault designation absent from the one or more fault identifiers; or
generate a data linkage between the fault designation absent from the one or more fault identifiers and at least one or the one or more fault identifiers.

14. The computer program product of claim 11, further comprising code that, when executed, causes the apparatus to deploy a trained machine learning (ML) model on the one or more fault designations from the one or more extracted device characteristics to determine a corresponding fault identifier.

15. The computer program product of claim 11, further comprising code that, when executed, causes the apparatus to:
access a data structure storing a plurality of candidate remediation destinations; and
determine the remediation destination from amongst the plurality of candidate remediation destinations based on the extracted device characteristics.

16. A method for dynamic data server fault steering in a distributed network, the method comprising:
receiving one or more data transmissions from a plurality of server devices forming a distributed network;
extracting one or more device characteristics from the one or more data transmissions, wherein the extracted device characteristics are indicative of at least a fault condition associated with one or more of the server devices from amongst the plurality of server devices forming the distributed network;
comparing one or more fault designations from the one or more extracted device characteristics with one or more fault identifiers;
determining a corresponding fault identifier for the one or more server devices based on the comparison;
determining a remediation destination for the fault condition based on the extracted device characteristics;
generating a remediation transmission for receipt by the determined remediation destination, wherein the determined remediation destination is configured to remedy the fault condition associated with the one or more server devices; and
determining an absence of a corresponding fault identifier for the one or more fault designations.

17. (canceled)

18. The method of claim 16, further comprising:
generating a new fault identifier corresponding to the one or more fault designation absent from the one or more fault identifiers; or
generating a data linkage between the fault designation absent from the one or more fault identifiers and at least one or the one or more fault identifiers.

19. The method of claim 16, further comprising deploying a trained machine learning (ML) model on the one or more fault designations from the one or more extracted device characteristics to determine a corresponding fault identifier.

20. The method of claim 16, further comprising:
accessing a data structure storing a plurality of candidate remediation destinations; and
determining the remediation destination from amongst the plurality of candidate remediation destinations based on the extracted device characteristics.
